(19) United States
(12) Patent Application Publication
(10) Pub. No.: US 2015/0244241 A1
(43) Pub. Date: Aug. 27, 2015

(54) ACTUATOR OF A FLAP OF A THERMAL ENGINE AIR CIRCUIT

(71) Applicant: VALEO SYSTEMES DE CONTROLE MOTEUR, Cergy Saint Christophe (FR)

(72) Inventor: Samuel Leroux, Poissy (FR)

(21) Appl. No.: 14/429,648

(22) PCT Filed: Sep. 20, 2013
(86) PCT No.: PCT/FR2013/052186

§ 371 Date: Mar. 19, 2015

(30) Foreign Application Priority Data
Sep. 20, 2012 (FR) 1258825

(51) Int. Cl. H02K 9/19

(52) U.S. Cl. CPC H02K 9/19

(57) ABSTRACT

The invention relates to a actuator (1) of a flap of a thermal engine air circuit, including: an engine (10) including a rotor (11) provided with a magnetic field source and a stator (12) provided with a magnetic field source, the stator (12) and the rotor (11) being concentric, and one among the magnetic field source of the rotor (11) and the magnetic field source of the stator (12) being formed by a winding of electrical conductors, while the other among the magnetic field source of the rotor (12) and of the stator (11) is formed by at least one permanent magnet, and a body (2) of the actuator, including a housing (3) which holds the electrical engine (10), the electrical engine (10) being such that when it is held in the housing (3) of the body (2), the magnetic field source that is closest to the body (2) is the winding of electrical conductors.

The present invention relates to an actuator for a flap of a thermal engine air circuit.

The invention applies in particular when the thermal engine is utilized for the propulsion of a vehicle, for example a motor vehicle. It may be an engine of which the fuel is petrol or diesel.

Within the meaning of the invention, the expression “thermal engine air circuit” is used to denote the circuit between the admission inlet and the exhaust outlet of the thermal engine. The flap may be positioned in the admission circuit, the exhaust circuit or a recirculation loop via which the exhaust gases that are reinjected for admission (EGR in English) pass. The flap may or may not be part of a valve.

Within the meaning of the invention, the expression “flap” must be understood in the broad sense, embracing every element for the regulation of the flow of gas in a pipe and every element for closing off the pipe.

The utilization of pneumatic actuators is known for the purpose of displacing the air circuit flaps. The increase in the need for displacing the flap in a flexible manner and with reduced transitory phases is today leading to the utilization of an electric motor to actuate the flap. Nevertheless, the electric motor in this application may be subjected to high temperatures, which are detrimental to it. These high temperatures may arise from the high values of the current supplying the electric motor in order for the latter to provide the flap with the desired torque. These high temperatures may also derive from the proximity to the air circuit, in particular when the flap is situated downstream of the combustion cylinders of the thermal engine and is consequently in a very hot environment.

The high temperatures may affect the very structure of the motor, for example the integrity of the electrical conductors on the stator and/or on the rotor which permit the creation of a magnetic field in the air gap when a current is flowing through them, and they may likewise affect the integrity of elements of the control electronics of the electric motor or the integrity of other elements, for example the position sensors of the output shaft of the actuator or of the shaft of the flap.

The need exists to be able to permit the utilization of an electric motor to displace a flap of a thermal engine air circuit, while ensuring that the temperature to which the electric motor is subjected remains acceptable by the latter.

The object of the invention is to respond to this need, and it does so, according to one of its aspects, with the help of an actuator for a flap of a thermal engine air circuit, comprising:
an electric motor comprising a rotor and a stator, each provided with a magnetic field source, the stator and the rotor being concentric, and one among the magnetic field source of the rotor and the magnetic field source of the stator being formed by a winding of electrical conductors, the other among the magnetic field source of the rotor and the magnetic field source of the stator being formed by at least one permanent magnet, and
a body of the actuator comprising a housing in which the electric motor is accommodated,
   the electric motor being such that, when it is accommodated in the housing of the actuator body, the magnetic field source that is closest to the body constitutes the winding of electrical conductors.

The axis of the electric motor and the longitudinal axis of the housing in the body may be coincident or parallel.

According to the above-mentioned actuator, a source of heat in the actuator, being the winding of electrical conductors, is positioned in proximity to the body of the actuator, in such a way as to encourage the dissipation of the heat in the housing towards the body of the actuator, which may thus be utilized as a radiator. As a result of this proximity, the thermal resistance due to the air between the winding of electrical conductors and the body of the actuator is reduced.

Thanks to this improved dissipation of the heat generated by the passage of current in the winding of electrical conductors, it is possible to increase the value of this current in order to obtain a higher torque for application to the flap, but without this affecting the integrity of the electric motor and without even being obliged to modify the rest of the actuator, and in particular the electrical conductors, that is to say the material from which they are made and/or their diameter and/or their thermal insulation and/or their disposition one in relation to the others within the winding.

The above-mentioned actuator thus permits the supply of a high torque while benefiting from reduced overall dimensions and a reduced cost price and from satisfactory dynamic performances.

As a variant, this configuration of the electric motor permitting a source of heat to be positioned in proximity to the body of the actuator may go hand-in-hand with an action on the winding of electrical conductors in order to improve the dissipation of the heat generated by the passage of a current in this winding. It is possible, for example, to act upon the choice of the material utilized to produce the electrical conductor, in order for the latter to permit the improved thermal dissipation of the heat generated by the passage of the current.

According to one illustrative embodiment of the invention, the magnetic field source of the rotor is formed by the one or more permanent magnets, and the magnetic field source of the stator is formed by the winding of electrical conductors. The electric motor according to this example is a motor with an internal rotor with permanent magnets and with a wound external stator.

The stator frame may be in contact with the wall of the actuator body defining the housing when the electric motor is accommodated in the latter. This direct contact further enhances the dissipation of heat towards the exterior of the actuator.

Such a configuration of the motor in relation to the choice of a wound internal rotor may permit the inertia of the rotor to be reduced because the latter is provided with magnets having a small radius in place of electrical conductors having a larger radius. An improved response time by the electric motor is obtained in this way when a torque setpoint is applied thereto.

The electric motor is preferably a direct current motor.

As a variant, the magnetic field source of the rotor is formed by the winding of electrical conductors, and the magnetic field source of the stator is formed by the one or more permanent magnets. The electric motor in this example is a motor having a wound external rotor and having an internal stator with permanent magnets.

The actuator may include a cooling circuit capable of carrying a flow of the heat transfer medium in such a way as to cool the winding of electrical conductors.

The cooling circuit permits the heat that is dissipated when the current is flowing in the winding of electrical conductors to be removed rapidly and in an efficient manner to the exterior of the actuator.

The cooling circuit may be connected to the cooling circuit of the thermal engine, in which case the engine coolant flows through it.

The cooling circuit may be accommodated in the wall of the body, in which case it is thus situated in proximity to the electric motor.

The portion of the wall of the body that is interposed between the cooling circuit and the housing may be made from a thermally conducting material, in particular from aluminum. The transfer of the heat that is dissipated in the winding of electrical conductors is thus encouraged towards the cooling circuit passing through said portion. Other portions of the body of the actuator, or indeed the totality of the latter, may be made from this thermally conducting material or from some other thermally conducting material.

As a variant, the cooling fluid comes directly into contact with the electric motor, in particular with the stator frame. The part of the housing in which the electric motor is positioned may then be provided with a system of sealing in relation to the exterior of said part of the housing.

The cooling circuit may comprise a plurality of pipes connected together and each extending parallel to the axis of the motor. The cooling circuit may thus pass back and forth for a certain number of times in parallel with the axis of the electric motor, in such a way as to maximize the exchange surface with the electric motor and to ensure that the flow of the heat transfer medium in the cooling circuit is turbulent.

Other geometries of the cooling circuit are possible, for example the utilization of walls provided with cavities for the cooling circuit. It is also possible to reduce the thickness of portions of the body that are adjacent to the pipes, in order to reduce the thickness of the body and the overall dimensions of the latter.

The cooling circuit may, or may not, extend over all or part of the circumference of the part of the housing in which the electric motor is accommodated. The cooling circuit exhibits an inlet and an outlet, for example, and the circuit may be positioned on all or part of the circumference of the housing between the inlet and the outlet.

In all the foregoing, the aim is to cool the electric motor by acting upon the dissipation of the heat that is generated inside this motor when the latter is being supplied electrically.

The invention may likewise make it possible to cool the electric motor while as far as possible preventing the external heat from reaching the interior of the actuator.

The actuator may comprise a transmission stage for the torque supplied by the electric motor. This stage is capable of transmitting this torque to the flap. Said stage may be accommodated in the housing of the actuator body and may be positioned in the prolongation of the motor, along the axis of the latter.

The electric motor and the transmission stage may thus follow one another along the axis of the motor, each preferably being accommodated in a separate part of the housing of the actuator body.

The transmission stage may comprise one or a plurality of pinions that are interposed between the shaft of the electric motor and an output shaft of the actuator. The transmission stage may in addition comprise one or a plurality of sensors, for example a sensor configured to determine the angular position of the output shaft of the actuator. This sensor comprises, for example, a magnetized target interacting with a magnetic detector, for example being a Hall effect sensor.

The cooling circuit may likewise extend around all or part of the part of the housing in which the transmission stage is accommodated. The transmission stage and the components that are sensitive to heat that are present in this stage may thus also be cooled in this stage, in order to protect them from the heat that is dissipated in the electric motor and/or from the heat that is external to the actuator and is likely to be propagated into the interior of the latter.

The wall of the actuator body in the area of the transmission stage may be covered by a thermal shield.

The electric motor may provide a torque in the range between 10 and 150 Nm at 160° C. for an output at the shaft of between 0.4 and 9 Nm.

A further object of the invention, according to another of its aspects, is an actuator for the flap of a thermal engine air circuit, comprising:
a direct current motor with an internal rotor, the rotor comprising one or a plurality of permanent magnets, and the stator comprising a winding of electrical conductors, and
an actuator body, comprising a housing in which the direct current motor is accommodated.

All or part of the previously mentioned characterizing features apply to this other aspect of the invention.

A further object of the invention, according to another of its aspects, is an assembly comprising:
an actuator as described above, and
a flap of a thermal engine air circuit.

The flap may comprise a shaft, and the actuator, in particular the transmission stage, may comprise an outlet shaft capable of transmitting the torque supplied by the electric motor to the shaft of the flap.

The actuator may comprise an electrical connector carried on a surface of the body opposite the surface of the body via which the coupling to the body is effected. This connector may permit the data captured by the one or more sensors of the actuator to be delivered towards the exterior of the body. The control electronics of the actuator may be situated externally to the actuator, for example accommodated in a module that is located in a cooler environment, and the connector may permit the control signals and the power signals emitted by said module to reach the interior of the actuator, in particular the electric motor. The electrical cables that are used inside the actuator to attach the connector to the electric motor and/or to the sensor(s) may be positioned along all or part of the length of pipes of the cooling circuit.

The assembly may comprise a system that is configured to connect said shafts mechanically, but not thermally.

Thanks to this system, the actuator may displace the flap thanks to the mechanical coupling, but without the heat in the environment of the flap being able to penetrate via this coupling into the interior of the actuator. This result is obtained, for example, when the output shaft of the actuator and the shaft of the flap are two separate components that are coupled mechanically by being fitted one into the other. The shaft of the flap may be provided with a plurality of fins disposed transversally, in particular perpendicularly, to its axis in order to encourage the dissipation into the air of the heat that is likely to flow through this shaft of the flap in order to be transmitted by conduction from the environment of the flap towards the actuator.

A connection of the actuator as close as possible to the shaft of the flap may be obtained.

The invention may make it possible to obtain an actuator of which the interior is protected from excessively high increases in temperature, with regard both to internal source(s) of heat and to external source(s) of heat. The thermal stresses that are imposed on sensitive elements of the actuator, for example the electrical conductors of the winding of the electric motor, and/or the control electronics and/or the measurement electronics, are reduced in this way while also improving the performance of the actuator in terms of its torque and/or response time.

The assembly may form a wastegate valve, although other valves may be formed.

The invention may be utilized, for example, to produce a turbo actuator with variable geometry, an actuator for a flap at the inlet of the “swirl” flap or “tumble” flap type, or also an actuator for a control valve of a water circuit of an engine.

As a variant, the assembly may be utilized to produce components other than valves. The invention will be more readily appreciated from a perusal of the following description of non-exhaustive embodiments for the implementation of the latter and from an examination of the accompanying drawing, in which:

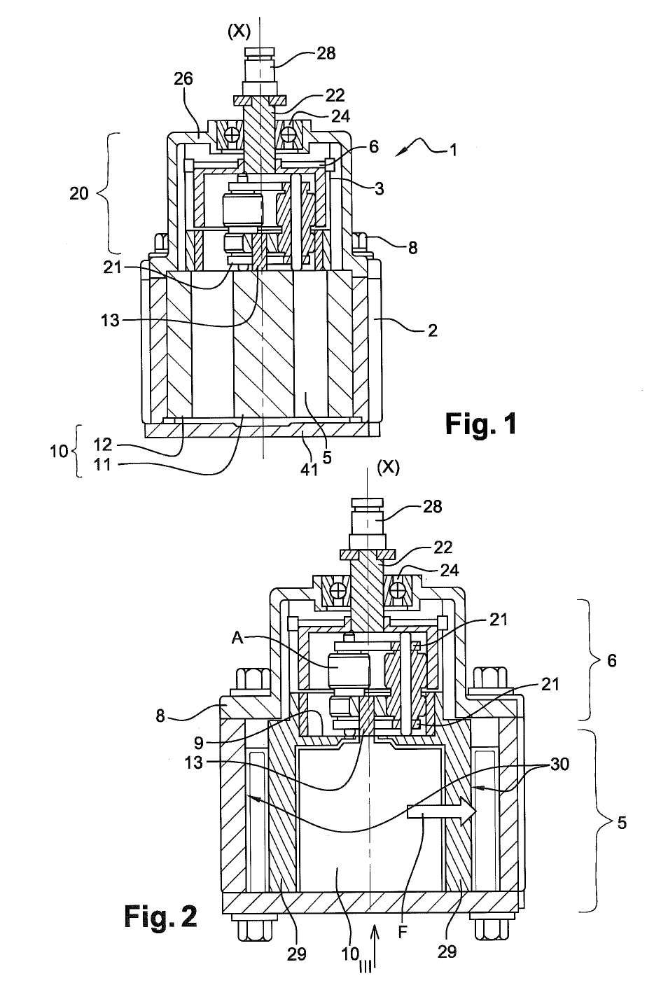

FIG. 1 depicts in a schematic manner and in cross section an actuator according to a first embodiment of the invention,

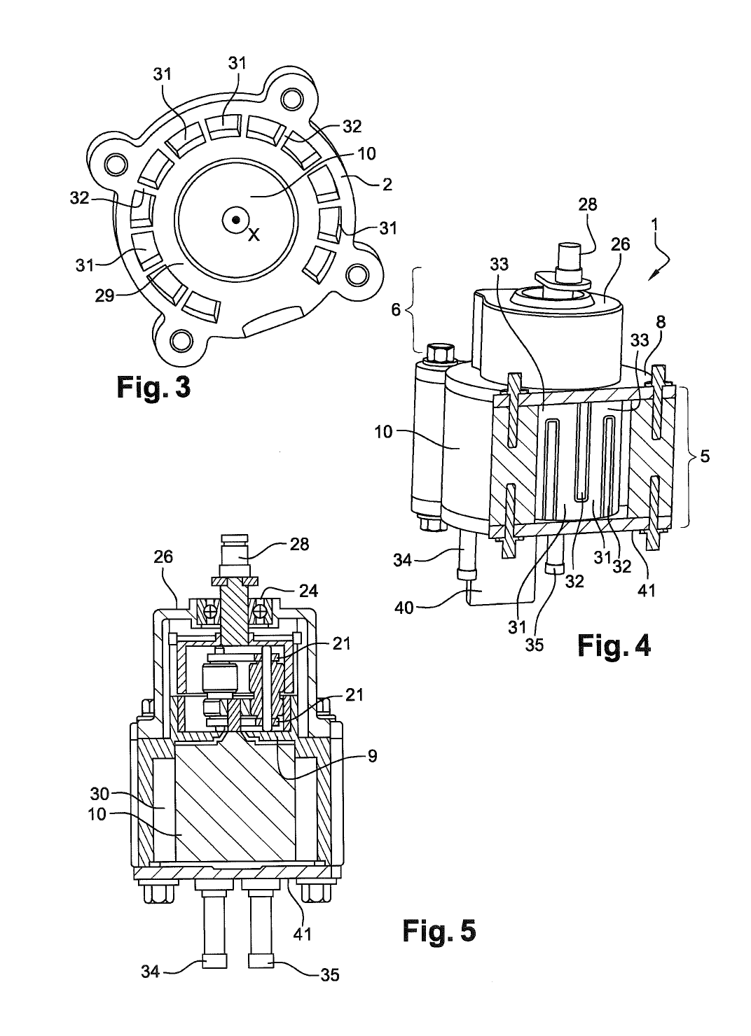

FIGS. 2 to 4 depict in a schematic manner and in cross section an actuator according to a second embodiment of the invention, FIG. 3 being a view from below according to III of the actuator in FIG. 2, FIG. 4 being a view similar to FIG. 2, in which a cross section of the wall of the body of the actuator in the area of the cooling circuit has been taken, and

FIG. 5 is a view similar to FIG. 2 depicting in a schematic manner a variant of the second embodiment of the invention.

An actuator 1 according to a first embodiment of the invention is described below with reference to FIG. 1. The actuator 1 according to this embodiment is an actuator for a flap of a thermal engine air circuit. The actuator 1 and the flap form a wastegate valve in the present case, although the invention is not restricted thereto.

As depicted, the actuator 1 comprises a body 2 extending in a longitudinal axis X. The body 2 is hollow, such that a housing 3 is arranged in the latter. The body 2 in this case is made from a conductive thermoplastic material, for example from aluminum.

The body 2 is intended to be secured to an element of the thermal engine, for example a soleplate attached to the cylinder head, by means of screws.

The housing 3 may comprise a first part 5 and a second part 6, as depicted in the figures, said parts 5 and 6 following one another along the axis X. Each part may be cylindrical in the axis X, and the radius of the first part 5 may be greater than that of the second part 6, the transition between said two parts 5 and 6 thus being defined by a return 8.

An internal wall 9 may separate the first part 5 from the second part 6 of the housing 3.

According to the embodiment depicted in FIG. 1, a direct current electric motor 10′is accommodated in the first part 5 of the housing. This electric motor 10 in this case is a motor with an internal rotor. The rotor 11 in this case comprises permanent magnets, whereas the stator 12 comprises a winding of electrical conductors with a direct current flowing through it. This winding is wound onto the frame of the stator 12. The frame of the stator comes into contact, for example, with the wall of the body 2 delimiting the first part 5 of the housing 3. The electrical conductors are made from copper, for example.

As can be seen, as a result of the configuration of the electric motor 10, the electrical conductors of the winding are in proximity to the body 2, such that the heat that is dissipated in the latter may be removed towards the exterior of the actuator 1 via the body 2.

The rotor 12 is rotationally fixed to a shaft 13 interacting with a transmission stage 20, which will now be described below.

The transmission stage 20 is positioned in the second part 6 of the housing 3. This transmission stage comprises, for example, a plurality of pinions 21 belonging to a planetary gear train permitting the torque transmitted by the shaft 13 of the electric motor 10 to be transmitted to an output shaft 22 of the actuator 1 that is capable of displacing the flap of the valve. The output shaft 22 is mounted, for example, on a bearing 24 maintaining it on an end surface 26 of the body 2 of the actuator 1. The output shaft 22 of the actuator 1 is coupled in the depicted example to a crank pin 28 that is capable of driving a flap (not illustrated here), although a direct coupling to the shaft of the flap is possible in one variant.

The transmission stage 20 in the example being considered here likewise comprises a sensor that is configured to determine the angular position of the output shaft 22.

The embodiment described with reference to FIGS. 2 to 5 differs from the previously described embodiment in the fact that the actuator 1 comprises a cooling circuit 30 permitting a heat transfer medium to extract the heat that is dissipated in the winding of the stator 12 because of the flow of current in the latter, as depicted by the arrow F in FIG. 2. In the example in FIGS. 2 to 4, the circuit 30 is arranged in the wall of the body 2 of the actuator 1, being separated from the housing 3 by a portion 29 of the body 2.

Conversely, in the example in FIG. 5, the coolant comes directly into contact with the electric motor 10, in which case the portion 29 is not present. In this example, a sealing system permits the tightness of the first part 5 of the housing to be assured in relation to the exterior of this first part 5.

The circuit 30 may be in the form of a plurality of rectilinear pipes 31 positioned parallel to the axis X, each occupying a different angular position around the axis X, and connected one to the other, as may be appreciated in FIGS. 3 and 4. These pipes 31 may be substantially identical and may be separated one from the other by means of a bulkhead 32 bordered on each side by a pipe 31. The connection between two adjacent pipes 31 may be effected by means of an opening 33 arranged in the bulkhead 32 that is bordered by these two adjacent pipes 31.

As depicted in FIG. 4, the cooling circuit 30 in the example being considered here comprises an inlet 34 and an outlet 35, said inlet 34 and said outlet 35 being arranged substantially in the same position along the axis X.

In the depicted example, twelve rectilinear pipes are provided, and the angular space occupied by these twelve pipes 31 and measured from the axis X lies in the range between 270° and 360°.

The cooling circuit 30 is coupled, for example, to the cooling circuit of the thermal engine, and the engine coolant liquid may flow through it.

Remaining with FIG. 4, it can be noted that the actuator 1 may comprise an electrical connector 40 permitting communication between the one or more sensors in the body 2 and a unit for processing these data. The connector 40 may likewise permit the electrical supply to the motor 10. The connector 40 in this example projects from a surface 41 of the body 2 opposite the surface 26.

In the example in FIGS. 2 to 5, the cooling circuit 30 does not cover the transmission stage 20 axially, extending only into the wall of the body 2 in the area of the first part 5 of the housing 3.

In a variant that is not depicted here, the cooling circuit 30 likewise extends in the area of the second part 6 of the housing 3. The pipes 31 are extended, for example, in such a way as to extend likewise into the wall of the body 2, at the same height as the second part 6 of the housing 3.

In this variant, a thermal shield may or may not cover the wall of the body 2 externally in the area of the transmission stage 20.

The invention is not restricted to an actuator 1 for the implementation of means for dissipating the heat that is generated solely by elements of this actuator.

The use of separate components to produce the output shaft 22 of the actuator 1 and the shaft driving the flap may permit the output shaft 22 to be decoupled thermally from the actuator 1 of the shaft driving the flap and, thereby, permit the heat in the environment of the flap to be prevented from reaching the housing 3. The mechanical coupling between these shafts may derive from the shape of corresponding extremities of these shafts, the latter being configured in particular so as to engage one in the other.

The invention is not restricted to the examples that have been described above.

The expression “comprising one” must be understood to be synonymous with the expression “comprising at least one”, unless specifically indicated to the contrary.

1. An actuator for a flap of a thermal engine air circuit, comprising:
a electric motor comprising a rotor and a stator, each provided with a magnetic field source, the stator and the rotor being concentric, and one among the magnetic field source of the rotor and the magnetic field source of the stator being formed by a winding of electrical conductors, the other among the magnetic field source of the rotor and the magnetic field source of the stator being formed by at least one permanent magnet, and
a body of the actuator comprising a housing in which the electric motor is accommodated,
the electric motor being such that, when it is accommodated in the housing of the body, the magnetic field source that is closest to the body is the winding of electrical conductors.

2. The actuator as claimed in claim 1, the magnetic field source of the rotor being formed by the one or more permanent magnets, and the magnetic field source of the stator being formed by the winding of electrical conductors.

3. The actuator as claimed in claim 1, the electric motor being a direct current motor.

4. The actuator as claimed in claim 1, including a cooling circuit capable of carrying a flow of the heat transfer medium in such a way as to cool the winding of electrical conductors.

5. The actuator as claimed in claim 4, the cooling circuit being accommodated in the wall of the body.

6. The actuator as claimed in claim 5, the portion of the wall of the body interposed between the cooling circuit and the housing being made from a thermally conducting material, in particular from aluminum.

7. The actuator as claimed in claim 1, the cooling fluid being capable of coming into contact with the electric motor.

8. The actuator as claimed in claim 4, the cooling circuit comprising a plurality of pipes connected together and each extending parallel to the axis of the electric motor.

9. The actuator as claimed in claim 4, the cooling circuit extending over all or part of the circumference of the part of the housing in which the electric motor is accommodated.

10. The actuator as claimed in claim 4, comprising a transmission stage for the torque supplied by the electric motor, said stage being accommodated in the housing of the body of the actuator and being positioned in the prolongation of the electric motor along the axis of the latter.

11. The actuator as claimed in claim 10, the cooling circuit likewise extending over all or part of the circumference of the part of the housing in which the transmission stage is accommodated.

12. The actuator as claimed in claim 11, the wall of the body in the area of the transmission stage being covered by a thermal shield.

13. An assembly comprising:
an actuator as claimed in claim 1, and a flap of a thermal engine air circuit.

14. The assembly as claimed in claim 13, the flap comprising a shaft and the actuator comprising an output shaft capable of transmitting the torque supplied by the electric motor to the shaft of the flap, the assembly comprising a system configured to connect said shafts mechanically, but not thermally.

15. The assembly as claimed in claim 13, forming a wastegate valve.
